(19) United States
(12) Patent Application Publication
(10) Pub. No.: US 2008/0168167 A1
(43) Pub. Date: Jul. 10, 2008

(54) SERVICE PROVIDED BY A SINGLE ENTITY FOR ALL APPLICATIONS

(76) Inventors: MICHAEL P. CALRSON, Austin, TX (US); LINDA A. LISLE, Cedar Park, TX (US); MICHAEL R. RHEINHEIMER, Austin, TX (US); HERMAN RODRIGUEZ, Austin, TX (US)

Correspondence Address: Greg Goshorn, P.C., 9600 Escarpment, Suite 745-9, AUSTIN, TX, 78749, US

(21) Appl. No.: 11/619,746

(22) Filed: Jan. 4, 2007

(51) Int. Cl. G06F 9/44; G06F 15/173

(52) U.S. Cl. 709/224; 717/168

(57) ABSTRACT

Provided is a system that enables a computer user to purchase and maintain installed operating systems and applications. Also provided is a method and system that detects and installs updates to programs and operating systems (OSs) on a computing system and ensures that the upgrades are compatible with existing software. A method is provided wherein a computer environment is scanned for all installed software and supporting files and logic such as libraries and OSs. A detected configuration is transmitted to a service provider who generates a service and support plan. The plan is offered to the administrator of the computer environment as an alternative to vendor-supplied plans. Thus, an administrator of a particular computing environment is able to centralize the maintenance and upgrade of installed software. The claimed technology provides access to a single-source pricing and support structure and enables the service provider to negotiate and purchase bulk upgrade packages.

### TECHNICAL FIELD

The present invention relates generally to computer support and, more specifically, to a method for providing service to a computer user based upon a total inventory of the user's machine.

### BACKGROUND OF THE INVENTION

As computers have proliferated over the past several decades, the number of available computer applications has grown exponentially. Types of applications include, but are not limited to, word processors, browsers, graphic programs, presentation programs, databases, file compression programs and security programs. In addition to applications, computers may host one or more operating systems, which control the processing and presentation of the various installed programs.

One issue that arises in view of the multitude of possible programs is the maintenance of those programs. Typically, different programs are sold by different vendors and/or publishers and each vendor may offer a support contract for their particular product. If a problem occurs, the computer user must first determine which product is the source of the problem, determine whether or not a support contract for that product has been purchased and, finally, contact the appropriate service personnel to address the problem. Further, a computer user must monitor the availability of updates, which are software fixes or patches distributed by software vendors, and upgrades, which are newly released versions of applications, often with new features.

In some cases, multiple products are bundled together and may share libraries of code. Of course, different products also need to work together. For example, a graphics or word processing program must work in conjunction with the installed operating system. Bundling and cooperation among programs makes the determination of the source of a problem difficult if not impossible for many users.

What is needed is a service or product that enables a computer user to easily purchase and maintain installed operating systems and applications. In addition, what is needed is a product that enables a user to detect and install updates and upgrades to installed programs and operating systems and ensure that the updates and upgrades are compatible with existing software.

### SUMMARY OF THE INVENTION

Provided is a method and system that enables a computer user to easily purchase and maintain installed operating systems and applications. Also provided is a method and system that detects and installs updates and upgrades to programs and operating systems on a computing system and ensures that the updates and upgrades are compatible with existing software.

A method, system and computer programming product is provided wherein a computer environment is scanned for all installed software, supporting files and logic such as, but not limited to, applications, software libraries and operating systems (OSs). The detected configuration is transmitted to a service provider and the service provider evaluates the configuration to generate a service and support plan based upon the configuration. The generated service and support is offered to the administrator of the computer environment as an alternative to vendor-supplied service plans corresponding to individual applications. If a service plan is purchased, service calls and help desk calls are routed to the service provider rather than to software vendors. Further, all update and upgrade information and implementation is routed through the service provider.

In this manner, an administrator or user of a particular computing environment is able to centralize the maintenance and update and upgrade of installed software, including applications, software libraries and OSs. The claimed technology also provides the user access to a competitive, single-source pricing and support structure. From a service provider's standpoint, the claimed subject matter enables the service provider to negotiate and purchase bulk upgrade packages and to offer these packages at competitive prices.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures, in which:

FIG. 1 is a block diagram of an exemplary computing system architecture that incorporates the claimed subject matter.

FIG. 2 is a block diagram of a software maintenance module (SMM), or client agent, first introduced in FIG. 1, in more detail.

FIG. 3 is a block diagram of a server agent, first introduced in FIG. 1, in more detail.

FIG. 4 is an exemplary graphical user interface (GUI) employed in conjunction with the SMM of FIGS. 1 and 2.

FIG. 5 is a flowchart of a generate plan process for implementing the claimed subject matter.

FIG. 6 is a flowchart of a configure client process employed in conjunction with the claimed subject matter.

FIG. 7 is a flowchart of a maintain software (SW) process for implementing the claimed subject matter.

### DETAILED DESCRIPTION OF THE FIGURES

Although described with particular reference to a personal computer (PC) based software and hardware system, the claimed subject matter can be implemented in any information technology (IT) system in which ease of maintenance is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for computer system maintenance. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

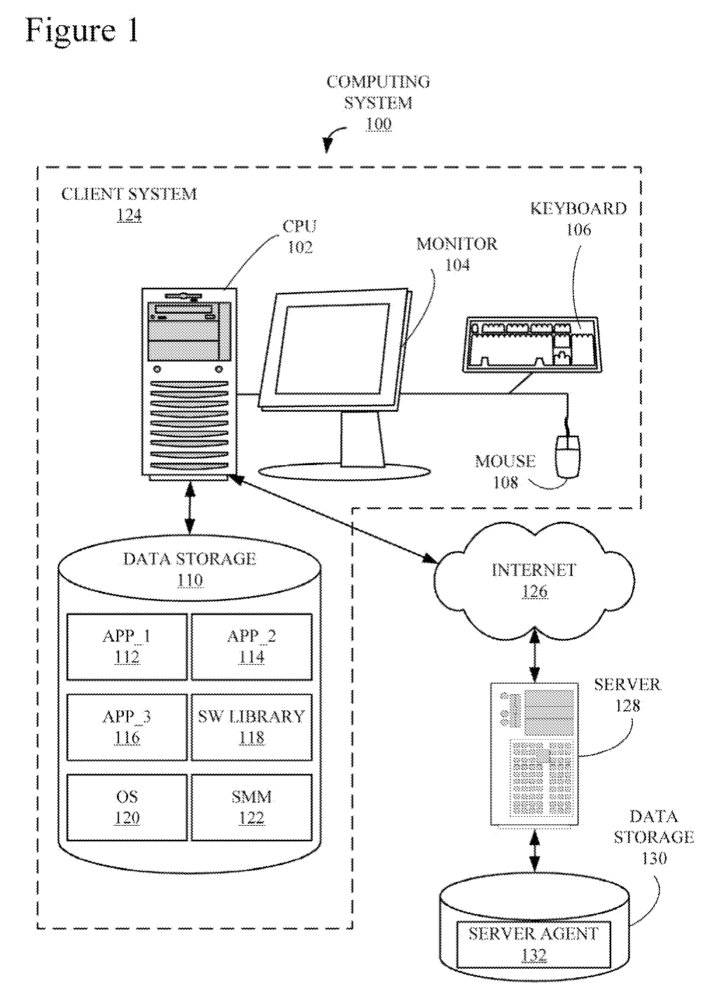

Turning now to the figures, FIG. 1 is a block diagram of an exemplary computing system architecture 100 that incorporates the claimed subject matter. A central processing unit (CPU) 102 is coupled to a monitor 104, a keyboard 106 and a mouse 108, which together facilitate human interaction with CPU 102 and computing system 100. Attached to CPU 102 is a data storage component 110, which may either be incorporated into CPU 102, i.e. an internal device, or attached externally to CPU 102 by means of various, commonly available connection devices such as but not limited to, a universal serial bus (USB) port (not shown). Data storage 110 is illustrated storing several exemplary applications, including a first application, or “App_1,” 112, a second application, or “App_2,” 114 and a third application, or “App_3,” 116. A software (SW) library 118 holds library routines that are shared by applications 112, 114 and 116. One issue that arises with respect to shared libraries such as library 118 is the compatibility of the applications that share the library with the modules of library 118. For example, a user may upgrade app_1 112 and, as a result, upgrade a particular module (not shown) in library 118, which is loaded by app_1 112 at runtime. In some cases, the upgraded library module may be incompatible to app_2 114, which also may load the particular module during runtime. Such an issue is one example of the issues that are automatically resolved as the result of the execution of the claimed subject matter.

CPU 102 is controlled by an operating system (OS) 120, which is stored on data storage 110 and in this example includes a graphical user interface (GUI) (not shown). Components 102, 104, 106, 108 and 110 are collectively referred to as a client system 124. Client system 124 is connected to the Internet 126, which is also connected to a server computer 128. Although in this example, client system 124 and server 128 are communicatively coupled via the Internet, they could also be coupled through any number of communication mediums such as, but not limited to, a local area network (LAN) (not shown).

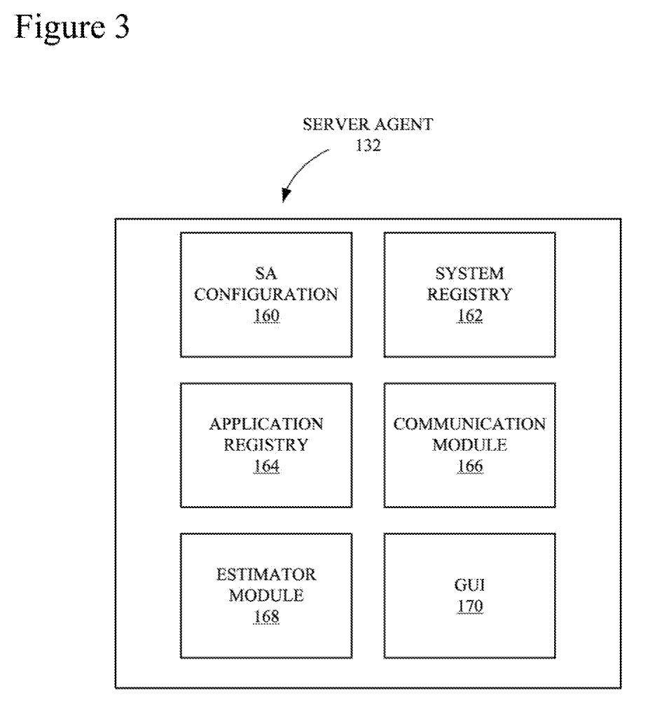

Server 128 is coupled to a data storage 130, which stores a server agent 132. Server agent 132 is described in more detail below in conjunction with FIGS. 3-7. Like data storage 110, data storage 130 may either be incorporated into server 128, i.e. an internal device, or attached externally to server 128 by means of various, commonly available connection devices such as but not limited to, a universal serial bus (USB) port (not shown).

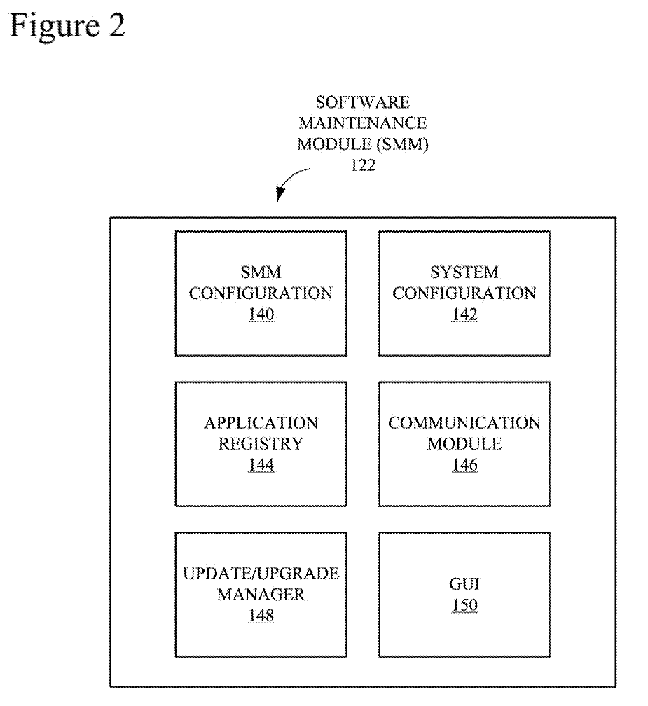

It should be understood that files such as app_1 112, app_2 114, app_3 116 and SW library 118, as well as many other files accessed by CPU 102, may be stored on data storage 130 coupled to server 128 and delivered over a LAN or Internet 126 to CPU 102 and/or data storage 110. It should also be noted that a typical computing system may include many applications and other files, but for the sake of simplicity only a few are shown. Also stored on data storage 110 is a software maintenance module (SMM) 122, or agent. SMM 122 implements the claimed subject matter and is described in more detail below in conjunction with FIGS. 2-7.

FIG. 2 is a block diagram of SMM 122, first introduced above in conjunction with FIG. 1, in more detail. In the following examples, the logic associated with SMM 122 is stored on data storage 110 (FIG. 1) and executes on CPU 102 (FIG. 1) of client system 124 (FIG. 1). SMM 122 includes a SMM configuration module 140, a system configuration module 142, an application registry 144, a communication module 146, an update/upgrade manager 148 and a graphical user interface (GUI) module 150. Functionality associated with components 140, 142, 144, 146, 148 and 150 are explained in more detail below in conjunction with FIGS. 3-7. In this example, SMM 122 manages applications and library 112, 114, 116 and 118 (FIG. 1) on client system 124, although, as mentioned above, SMM 122 could be installed on server 128 and manage client system 124 as well as outer computing systems (not shown) communicatively coupled to server 128.

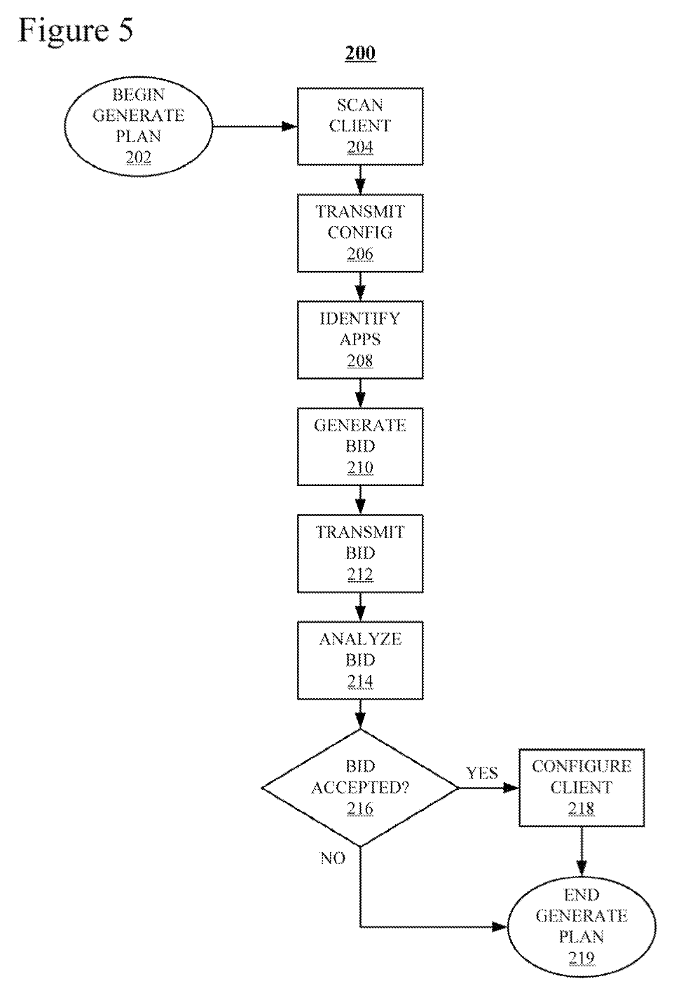

Briefly, SMM configuration module 140, stores information related to the configuration of SMM 122. Typically, module 140 is configured by a third-party software service provider to implement the claimed subject matter. However, the user of client system 124 can set certain parameters. For example, configuration information may include, but is not limited to, parameters associated with the time and how often SMM 122 executes, whether or not SMM 122 executes automatically or must be explicitly initiated and whether or not SMM 122 operates as a background or a foreground process. System configuration module 142 stores information relating to the system on which SMM 122 is installed or upon which SMM 122 is configured to operate. In addition, module 142 includes logic to scan client system 124 for the existence of all installed software, such as applications and library 112, 114, 116 and 118. The scanning process of system configuration module 142 stores information in application registry 144 and is described in more detail below in conjunction with FIG. 5.

Application registry 144 stores information related to the entities, such as applications 112, 114 and 116 and library 118, managed by SMM 122. Such information includes, but is not limited to, application names, version numbers, dependencies and information on the location of update and upgrade information for the corresponding applications. For example, if app_1 112 is Word, published by the Microsoft Corporation of Redmond, Wash., application registry may store the web address of Microsoft so that current information about Word can be periodically located. Of course, some software vendors transmit notification of new versions and software fixes rather than requiring that users periodically check. In that case, communication module 146 is designated as the recipient of such information on behalf of SMM 122. Further, user access to menu options such as “Help” and “About” associated with applications listed in application registry 144 are directed, via communication module 146, to server agent 132 (FIGS. 1 and 3).

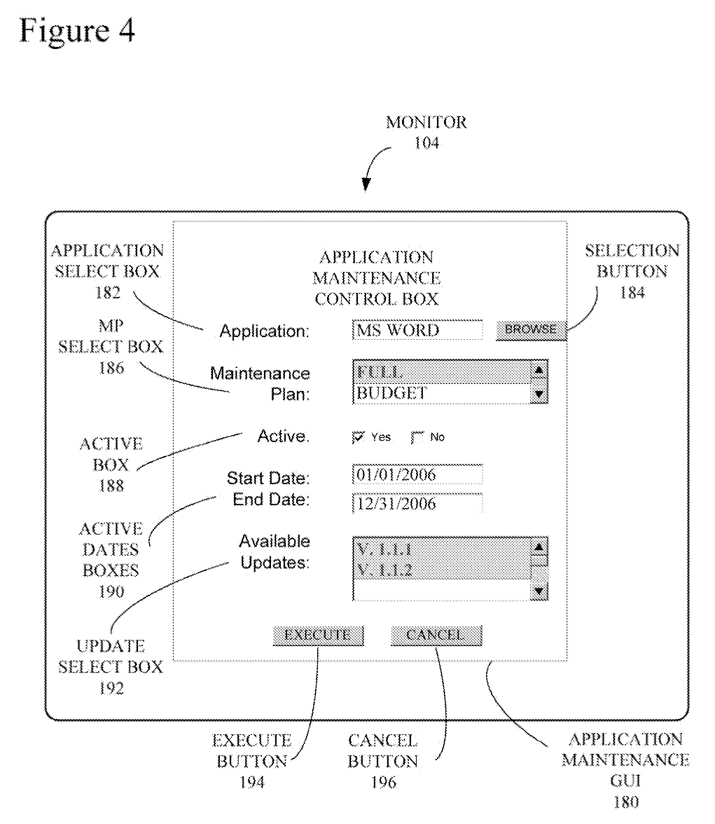

Update/upgrade manager 148 stores logic for executing upgrades and fixes relating to applications and other packages maintained by SMM 122. Update/upgrade manager 148 includes logic for ensuring that updates in library 118 are compatible with any installed applications. Typically, update/upgrade manager 148 is maintained by server agent 132. GUI module 150 stores information for generating GUIs that enables a user to configure SMM 122. One example of a GUI associated with GUI module 150 is described below in conjunction with FIG. 4.

Configuration information includes data described above as stored in modules 140, 142, 144, 146, 148 and 150. It should be noted that the information and logic of SMM 122 and components 140, 142, 144, 146, 148 and 150 may periodically be updated by SMM 122 such that SMM 122 is capable of executing a certain degree of self maintenance in accordance with the claimed subject matter.

FIG. 3 is a block diagram of server agent 132, first introduced in FIG. 1, in more detail. In the following examples, the logic associated with server agent 132 is stored on data storage 130 (FIG. 1) and executes on a CPU (not shown) coupled to server 128 (FIG. 1). Server agent 132 includes a server agent (SA) configuration module 160, a system registry 162, an application registry 164, a communication module 166, an estimator module 168 and a GUI module 170. Functionality associated with components 160, 162, 164, 166, 168 and 170 are explained in more detail below in conjunction with FIGS. 4-7.

Briefly, SA configuration module 160, stores information related to the configuration of server agent 132. Examples of the types of parameters stored in module 160 include, but are not limited to, login information corresponding to administrators of server agent 160, requirements related to particular SMM 122 modules corresponding to specific clients and display information relating to GUIs associated with server agent 132. System registry 162 stores information relating to systems that are authorized to communicate with server agent 132, such as client system 124. Application registry 164 stores information relating to various software components and applications that the claimed system is configured to maintain. Examples of information stored by module 164 include, but are not limited to, various levels of support and pricing for supported applications and contact information, such as an application's websites and telephone numbers for technical support.

Communication module 166 manages communication tasks between server agent 132 and both client agents and application vendor sites. Vendor sites are typically contacted periodically to check for the availability of upgrades and software patches. Estimator module 168 takes information received by client agents, such as SMM 122, and generates a pricing scheme for the maintenance of the applications associated with the client agent based on information generated by system configuration module 142 of SMM 122. In one embodiment, the estimate generated by module 168 is returned to the SMM 122 that initiated contact; in a second embodiment, the estimate is routed to an administrator of server agent 132 and employed to prepare a comprehensive estimate for maintenance services to client system 124. A comprehensive estimate may also include multiple systems corresponding to multiple client agents on different client systems. Finally, GUI module 170 generates GUIs (not shown) on server 128 for tasks such as the configuration of server agent 132, the addition and deletion of registered systems and applications and the generation of comprehensive maintenance service contracts.

FIG. 4 is an exemplary application maintenance GUI 180, entitled Application Maintenance Control Box, employed in conjunction with SMM 122 of FIGS. 1 and 2. GUI 180 is executed on CPU 102 (FIG. 1) and displayed on monitor 104 (FIG. 1) of client system 124 (FIG. 1). GUI 180 enables a user to select installed applications, such as applications 112, 114 and 116 (FIG. 1), to examine and modify available maintenance plans for the applications. Of course, OS 120 (FIG. 1) may also be included under the maintenance of the claimed subject matter. Information entered in GUI 180 is stored under each or any of modules 140, 142, 144 and 148 (FIG. 2) of SMM 122.

GUI 180 includes an application select box 182 that specifies which particular application is the current subject of GUI 180. In this example, the current application is Microsoft (MS) Word, a common word processing program described above as app_1 112. A selection button 184 enables the user to search a directory structure (not shown) corresponding to client system 124 for available applications. A maintenance plan (MP) select box 186 enables the user to select various maintenance options. In this example, there are two (2) plans, a “Full” maintenance and a “Budget” plan, or which the Full plan is selected.

An active box 188 enables the user to turn a particular maintenance plan on or off. In this example, the plan is turned on. Active dates boxes 190 specify a start date and an end date for the corresponding maintenance plan. In this example, the plan begins on Jan. 1, 2006 and expires on Dec. 31, 2006. Like box 186, active date boxes 190 are employed both to display a current plan and to enable the user to modify the current plan. In the event a current plan is modified, communication module 146 (FIG. 2) transmits the updated information to server agent 132 (FIG. 3) so that estimator module 168 (FIG. 3) can generate a new pricing structure, which is transmitted back and displayed to the user.

An available updates box 192 displays all uninstalled updates currently pending for the application displayed in box 182. In this example, two (2) updates are available, a version 1.1.1 and a version 1.1.2, both of which are selected for execution. An execute button 194 enables the user to communicate the information in GUI 180 to server agent 132, implement the selected upgrades in box 192 and transmit any modifications to the maintenance plan displayed in box 182. A cancel button 196 enables the user to exit GUI 180 without implement any changes or executing any updates.

FIG. 5 is a flowchart of a generate plan process 200 for implementing the claimed subject matter. Portions of process 200 are executed on CPU 102 (FIG. 1) of client system 124 (FIG. 1) and portions are executed on a CPU (not shown) of server 128 (FIG. 1). Process 200 describes the interaction between SMM 122 (FIGS. 1 and 2) and server agent 132 (FIGS. 1 and 3).

Process 200 starts in a “Begin Generate Plan” block 202 and proceeds immediately to a “Scan Client” block 204. During block 204, system configuration module 142 (FIG. 2) of SMM 122 searches data storage 110 (FIG. 1) of client system 124 (FIG. 1) for the existence of applications, software libraries and an OS such as applications 112, 114 and 116 (FIG. 1), SW library 118 (FIG. 1) and OS 120 (FIG. 1), respectively. In addition to noting the existence of the various software entities 112, 114, 116, 118 and 120, module 142 also determines and stores information relating to the versions and upgrade status of the scanned entities into application registry 144 (FIG. 2). Of course, a typical computing system has more than three (3) applications and more than one (1) data storage device but for the sale of simplicity only one memory device and a few applications are shown. The disclosed technology is equally applicable to more complex systems than the computing system illustrated.

During a “Transmit Configuration (Config)” block 206, the information stored in application registry 144 is transmitted by communication module 146 (FIG. 2) of SMM 122 to communication module 166 (FIG. 3) of server agent 132 via Internet 126 (FIG. 1). During an “Identify Apps” block 208, server agent 132 identifies the applications 112, 114 and 116, components of SW library 118 and OS 120, as listed in application registry 144 by comparing the transmitted information with the information stored in application registry 164 (FIG. 3). As mentioned above in conjunction with FIG. 3, application registry 164 stores information relating to various software components and applications that the server 132 is configured to maintain. Examples of information stored by module 164 include, but are not limited to, various levels of support and pricing for supported applications and contact information, such as an application's websites and telephone numbers for technical support.

During a “Generate Bid” block 210, process 200 generates a plan for maintaining the software 112, 114, 116, 118 and 120 of client system 124. The plan, or bid, is generated by estimator module 168 (FIG. 3) using the information transmitted during block 206 and the information identified during block 208 that corresponds to the transmitted information. During a “Transmit Bid” block 212, communication module 166 transmits the bid generated during block 210 to communication module 146 of SMM 122 via Internet 126.

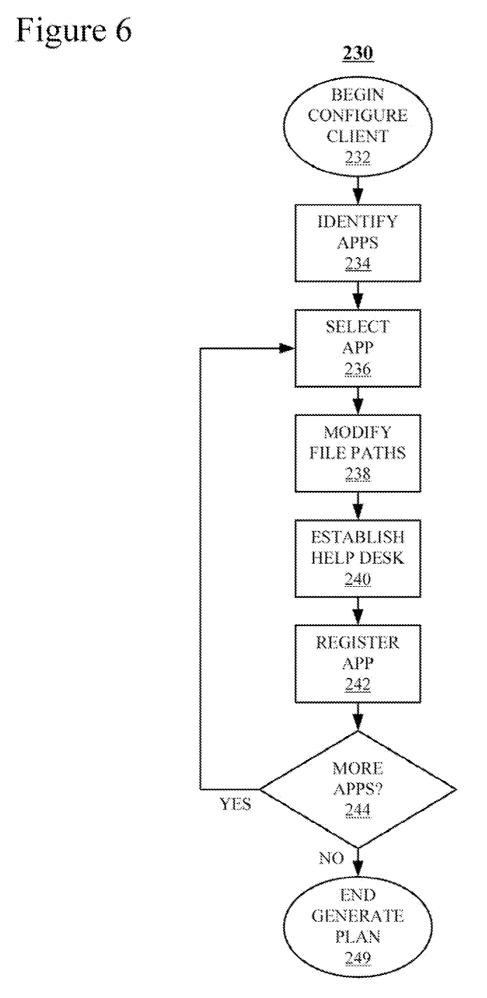

During an “Analyze Bid” block 214, the administrator of client system 124 evaluates the service bid transmitted during block 212 and determines whether or not to purchase the provided service. During a “Bid Accepted?” block 216, process 200 determines whether or not the bid transmitted during block 212 and evaluated during block 214 has been accepted by the administrator of client system 124. If so, process 200 proceeds to a “Configure Client” block 218, which is described in more detail below in conjunction with FIG. 6. If process 200 determines, during block 216 that the bid has not been accepted or following execution of block 218, process 200 proceeds to an “End Generate Plan” block 219 in which process 200 is complete.

FIG. 6 is a flowchart of a Configure Client process 230 employed in conjunction with the claimed subject matter. Process 230 corresponds to configure client block 218 described above in conjunction with FIG. 5. Process 230 is typically executed on client system 124 (FIG. 1) under the direction of server agent 132 (FIG. 1).

Process 230 starts in a “Begin Configure Client” block 232 and proceeds immediately to an “Identify Applications (Apps)” block 234. During block 234, process 230 determines which applications, libraries and OSs are the subject of the service bid transmitted during Transmit Bid block 212, described above in conjunction with process 200 of FIG. 5. Although an administrator of client system 124 (FIG. 1) would typically configure all software on client system 124 under the maintenance of the claimed subject matter, one embodiment enables the administrator to select specific software for maintenance under the service bid. Once all the software, or in the alternative the software selected for the maintenance program, are identified, process 230 proceeds to a “Select App” block 236 during which process 230 selects one of the applications identified during block 234, or the “target app,” to process.

During a “Modify File Paths” block 238, process 230 modifies relevant file paths associated with the application or software selected during block 236 so that the location of help, contact and upgrade paths point to server agent 132 (FIGS. 1 and 3) rather than the default entities, typically the publisher of the software. During an “Establish Help Desk” block 240, process 230 correlates the application or software selected during block 236 with a help desk associated with server agent 132. During a “Register App” block 242, process 230 lists the application, as well as the file paths and help desk information established during blocks 238 and 240 in application registry 168 (FIG. 2) of SMM 122 (FIGS. 1 and 2) and lists client system 124 in system registry 162 (FIG. 3) of server agent (FIGS. 1 and 3), if process 230 has not already done so in a previous iteration through blocks 242.

Finally, during a “More Apps?” block 244, process 230 determines whether or not all applications and other software selected to be part of the maintenance plan have been processed. If not, process 230 returns to Select App block 236 during which another unprocessed application or software is selected and processing continues as described above. If so, process 230 proceeds to an “End Configure Client” block 249 in which process 230 is complete.

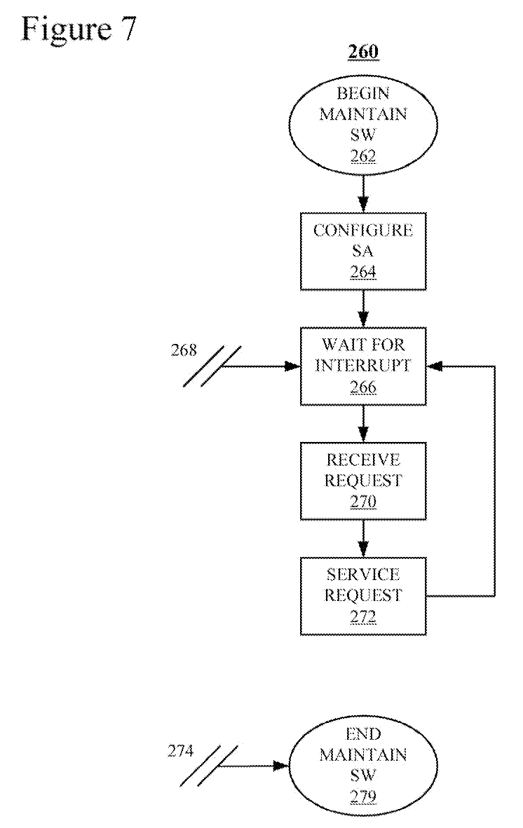

FIG. 7 is a flowchart of a maintain software (SW) process 260 for implementing the claimed subject matter. Process 260 executes on server 128 (FIG. 1) and associated with server agent 132 (FIGS. 1 and 3). Process 260 starts in a “Begin Maintain software (SW)” block 262 and proceeds immediately proceeds to a “Configure Server Agent (SA)” block 264. During block 264, process 260 employs data stored in SA configuration 160 (FIG. 3), system registry 162 (FIG. 3) and application registry 164 (FIG. 3) to configure server agent 132.

During a “Wait for Interrupt” block 266, process 260 is in a suspended execution state while waiting for an asynchronous interrupt 268. As should be apparent to those with skill in the computing arts, process 260, and therefore server agent 132, is basically an interrupt driven process. Interrupt 268 may be one of several different types of interrupts such as, but not limited to, an interrupt generated by communication module 166 (FIG. 3) in response to a bid transmitted by SMM 122 (FIGS. 1 and 2) as described above in conjunction with FIG. 5. Other examples include an interrupt generated by communication module 166 in response to a notice from a software vendor of an available update to an application registered in application registry 164 (FIG. 3) and an interrupt generated by an internal timer (not shown) to periodically check with software vendors for updates to registered applications. Interrupts are also generated by communication module 166 in response to help or help desk requests form SMM 122.

Once interrupt 268 is received, process 260 proceeds to a “Receive Request” block 270 during which process 260 determines the type of interrupt and the appropriate action to take in response. During a “Service Request” block 272, process 260 either executes action to satisfy the request or signals a technician associated with server 132 so the technician can address the issue. Once the request received during block 270 is serviced during block 272 process 260 returns to wait for Interrupt block 266 and processing continues as described above.

Finally, process 260 is designed to operate continuously. If a shutdown of server 132 occurs or an administrator needs to shut down server agent 132, an asynchronous interrupt 274 causes control to proceed to an “End Maintain SW” block 279 during which process 260 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for providing support to a computer user, comprising:
scanning a computing system to determine a computing system configuration;
generating an inventory of applications on the computing system based upon the scanning;
creating a service and support bid for remotely maintaining the computing system based upon the inventory and the configuration; and
providing support to the user of the computing system based upon the bid.

2. The method of claim 1, wherein the computing system configuration includes information from a list comprising:
library files;
operating system; and
installed software.

3. The method of claim 1, providing support comprising:
detecting conflicts between applications; and
resolving the detected conflicts between applications.

4. The method of claim 1, providing support comprising:
detecting an update corresponding to an application listed on the inventory;
determining potential conflicts between the update and non-corresponding applications on the inventory;
resolving the potential conflicts; and
implementing the updates on the computing system.

5. The method of claim 1, providing support comprising modifying applications associated with unrelated software providers to redirect support requests and help queries to a single remote service center corresponding to the support provider rather than to a software provider of the unrelated software providers.

6. The method of claim 1, providing support comprising:
monitoring software providers corresponding to applications listed in the inventory for upgrades to the applications;
notifying the user of the computing system of a detected upgrade; and
installing the detected upgrade on the computing system.

7. The method of claim 1, further comprising:
grouping a plurality of supported users corresponding to a plurality of computing systems into a pricing group;
negotiating a bulk upgrade price for an application associated with multiple users of the plurality of supported users; and
pricing an upgrade of the application associated with multiple users based upon the bulk upgrade price rather than an individual upgrade price.

8. A system for providing support to a computer user, comprising:
a service computing system for implementing the system;
logic, executed on the service computing system, for querying a computing system corresponding to a user to determine a computing system configuration for the user's computing system;
logic, executed on the service computing system, generating an inventory of applications on the user's computing system based upon the query;
logic, executed on the service computing system, creating a service and support bid for remotely maintaining the user's computing system based upon the inventory and the configuration; and
logic, executed on the service computing system, providing support for the user's computing system based upon the bid.

9. The system of claim 8, the computing system configuration information comprising:
library file information;
operating system information; and
installed software information.

10. The system of claim 8, the logic for providing support comprising:
logic for detecting conflicts between applications; and
logic for resolving the detected conflicts between applications.

11. The system of claim 8, the logic for providing support comprising:
logic for detecting an update corresponding to an application listed on the inventory;
logic for determining potential conflicts between the update and non-corresponding applications on the inventory;
logic for resolving the potential conflicts; and
logic for implementing the updates on the user's computing system.

12. The system of claim 8, the logic for providing support comprising logic for modifying applications associated with unrelated software providers to redirect support requests and help queries to a single remote service center corresponding to the support provider rather than to a software provider of the unrelated software providers.

13. The system of claim 8, the logic for providing support comprising:
logic for monitoring software providers corresponding to applications listed in the inventory for upgrades to the applications;
logic for notifying the user's computing system of a detected upgrade; and
logic for installing the detected upgrade on the user's computing system.

14. The system of claim 8, further comprising:
logic, executed on the service computing system, for grouping a plurality of supported users corresponding to a plurality of user computing systems into a pricing group;
negotiating a bulk upgrade price for an application associated with multiple users of the plurality of supported users; and
pricing an upgrade of the application associated with multiple users based upon the bulk upgrade price rather than an individual upgrade price.

15. A computer programming product for providing support to a computer user, comprising:
a memory;
logic, stored on the memory, for scanning a computing system to determine a computing system configuration;
logic, stored on the memory, for generating an inventory of applications on the computing system based upon the scanning;
logic, stored on the memory, for creating a service and support bid for remotely maintaining the computing system based upon the inventory and the configuration; and
logic, stored on the memory, for providing support to the user of the computing system based upon the bid.

16. The computer programming product of claim 15, wherein the computing system configuration includes information from a list comprising:
library files;
operating system; and
installed software.

17. The computer programming product of claim 15, the logic for providing support comprising:
logic for detecting conflicts between applications; and
logic for resolving the detected conflicts between applications.

18. The computer programming product of claim 15, the logic for providing support comprising:
logic for detecting an update corresponding to an application listed on the inventory;
logic for determining potential conflicts between the update and non-corresponding applications on the inventory;
logic for resolving the potential conflicts; and
logic for implementing the updates on the computing system.

19. The computer programming product of claim 15, the logic for providing support comprising logic for modifying applications associated with unrelated software providers to redirect support requests and help queries to a single remote service center corresponding to the support provider rather than to a software provider of the unrelated software providers.

20. The computer programming product of claim 15, the logic for providing support comprising:
logic for monitoring software providers corresponding to applications listed in the inventory for upgrades to the applications;
logic for notifying the user of the computing system of a detected upgrade; and
logic for installing the detected upgrade on the computing system.
